(19) United States
(12) Patent Application Publication
(10) Pub. No.: US 2008/0310543 A1
(43) Pub. Date: Dec. 18, 2008

(54) Modulator with Instantaneous Modulation Scheme Switching in Multi-Time Slot and Multi-Mode Operation, for a Wireless Communication Equipment

(75) Inventors: Markus Helfenstein, Lucerne (CH); Peter R. Bode, Nurenberg (DE); Lampe Alexander, Leipzig (DE)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: KONINKLIJKE PHILIPS ELECTRONICS N.V., Eindhoven (NL)

(21) Appl. No.: 11/572,912

(22) PCT Filed: Jul. 12, 2005
(86) PCT No.: PCT/IB2005/052309

§ 371 Date: Jan. 29, 2007

(30) Foreign Application Priority Data
Jul. 29, 2004 (EP) 04300494.4

(51) Int. Cl. H04L 27/00

(52) U.S. Cl. 375/295

(57) ABSTRACT

A modulator (M) which may be installed in a wireless communication equipment, comprises i) a modulation means (SPC, M0, GM, CM0, CMI, MX1, US1) for generating digital I/Q signals associated to time slots of a group of time slots, filled with data bits of a burst and separated one from the others by a guard interval filled with guard bits, ii) a filter means (F0) for applying a chosen pulse shape defined by filter values to the digital I/Q signals to output modulated digital I/Q signals, and iii) initialization means (SPC′, M0′, GM′, CM0′, US1′, US2′, MX0) arranged, upon reception of a transmit burst of digital I/Q signals, to feed the filter means with chosen rotated valid symbols, time-aligned with consecutive guard bits and data bits respectively filling a guard interval and the consecutive time slots that enclose it, before transmission to the filter means of the last guard bits filling the guard interval, and/or with digital I/Q signals set to zero just after transmission to the filter means of the last data of the transmit burst.

The present invention relates to the digital transmission part of wireless communication equipments, and more precisely to modulators adapted to switch from one modulation scheme to another between two data bursts associated to consecutive time slots.

In certain communication networks, such as GSM (Global System for Mobile communications), it has been proposed to enhance the data rate through new standards, such as the so-called EGPRS standard (Enhanced General Packet Radio Service). For instance the EGPRS standard has introduced in the GSM network a new modulation scheme, named 8PSK (8 Phase Shift Keying), to improve the data rate previously offered by the GMSK (Gaussian Minimum Shift Keying) modulation scheme.

For flexibility purpose of data transmission, the EGPRS standard defines a multi-time slot (or multislot) and multi-mode operation requiring that more than one time slot out of the eight time slots dividing a GSM frame could be used for data transmission with GMSK or 8PSK modulation. So, the EGPRS wireless communication equipments must comprise a modulator able to switch easily from a GMSK modulation scheme to an 8PSK modulation scheme and vice versa in consecutive time slots.

But, as it is known by one skilled in the art, GMSK is a constant envelope modulation scheme which allows the use of a saturated power amplifier with high efficiency, while 8PSK is a modulation scheme which delivers a modulated carrier that varies not only in amplitude but also in phase and therefore can not allow the use of a saturated power amplifier but for instance a linear one.

So, in multislot operation the modulation scheme changes but also possibly the power amplification mode, which unfortunately introduces interferences between the adjacent channels associated to consecutive time slots.

In order to reduce these interferences it has been proposed to ramp down the transmit power by means of the power amplification and to change the modulator and/or the power amplification mode during a guard period provided between the consecutive time slots. It is recalled that the guard period is a time interval dedicated to control and/or switching operation without data transmission.

An alternative to this solution has been notably described in the patent document WO 2004/021659. It consists of a joint GMSK/8PSK I/Q modulator adapted to power ramping by means of I/Q signal shaping (where I and Q are respectively in-phase and quadrature components), without changing neither the power amplification mode nor the modulators. More precisely, when the GMSK part of the joint GMSK/8PSK I/Q modulator is approximated with a sufficient number of linear and pre-encoded modulators chosen by means of a Laurent's representation, and when the modulator inputs signals are appropriately chosen, a burst shaping can be carried out in the I/Q domain and thereby the problem of power ramping is solved.

This requires that the modulator function is decoupled from the power control loop, or in other words that the ramping of the power amplifier is not determined by the modulator behaviour, but strictly by the power control loop. But, this stringent condition requires that the modulator output signal has an instantaneous transition between on/off states (data mode versus forced-zero mode) rather than a smooth one. Unfortunately, the above described GMSK/8PSK I/Q modulator suffers from a relatively slow on/off output signal transition which renders the power control loop of the saturated power amplifier, which is to be used preferably for GMSK, difficult to control especially when the guard period is reduced to a small number of bits or symbols (for instance 5 bits for timing advance bursts).

So, the object of this invention is to improve the situation notably when the modulator is of the type of the one disclosed in the above cited patent document WO 2004/021659.

For this purpose, it provides a modulator, for a wireless communication equipment, comprising i) a modulation means for generating digital I/Q signals associated to time slots of a group of time slots, filled with data bits of a burst and separated one from the others by a guard interval filled with guard bits, and ii) filter means for applying a chosen pulse shape defined by filter values to the digital IQ signals to output modulated digital I/Q signals.

This modulator is characterized in that it comprises initialization means arranged, upon reception of a transmit burst of digital I/Q signals, to feed the filter means with chosen rotated valid symbols, time-aligned with consecutive guard bits and data bits respectively filling a guard interval and the consecutive time slots that enclose it, before transmission of the last guard bits (filling this guard interval) to the filter means and/or with digital I/Q signals set to zero just after transmission of the last data of the transmit burst to the filter means.

The modulator according to the invention may include additional characteristics considered separately or combined, and notably:
its initialization means may be arranged to feed a processing means input of its modulation means with a chosen constant value in association with the feeding of the filter means with the chosen rotated valid symbols. For instance, the constant value may be equal to “1” or “0”,
it may comprise a reset means arranged to feed the filter means, just after transmission to the filter means of the last data of the transmit burst, with a reset sequence of signals forced to zero, in order the filter means outputs modulated digital I/Q signals forced to zero,
its modulation means may comprise at least first, second and third modulation means, its initialization means may comprise at least first and second, and possibly third initialization means, and its filter means may comprise at least a first filter means coupled to the first and third modulation means through a first multiplexing means, and a second filter means coupled to the second modulation means through a second multiplexing means,
   on the one hand the first and second filter means are preferably finite impulse response filters each divided into stages and outputting respectively first and second modulated digital I/Q signals, and on the other hand the modulator may comprise a combination means arranged to combine the first and second modulated digital I/Q signals to constitute the modulated digital I/Q signals,
   the first, second and the possible third initialization means may each comprise at least a mapper respectively fed with a chosen bit sequence and a multiplier comprising a first input coupled to the mapper and a second input fed with chosen rotation signals (or term) and adapted to deliver the rotated valid symbols as a function of the rotation signals and the chosen bit sequence. In this case, the second initialization means may also comprise a finite state machine fed with the chosen bit sequence and feeding the mapper, and the possible third initialization means may also comprise a serial to parallel converter fed with the chosen bit sequence and feeding the mapper. Moreover, the first and third initialization means may share a multiplexer comprising at least first and second inputs respectively connected to the corresponding multipliers and one output feeding a shared up-sampler connected to the first filter means. This shared multiplexer may also comprise a third input for introducing the reset sequence of signals forced to zero,
   the first and second initialization means are preferably fed with the same bit sequence,
   the first modulation means and the first filter means may define a zero-th order of a linearized GMSK I/Q modulator, the second modulation means and the second filter means may define a first order of this linearized GMSK I/Q modulator, the zero-th order and first order of the linearized GMSK I/Q modulator being fed with common digital GMSK I/Q signals, and the third modulation means and the first filter means may define an 8PSK I/Q modulator fed with digital 8PSK I/Q signals.

The invention also provides a wireless communication equipment comprising a modulator such as the one above introduced. Such an equipment may be a mobile phone, for instance.

Other features and advantages of the invention will become apparent on examining the detailed specifications hereafter and the appended drawings, wherein:

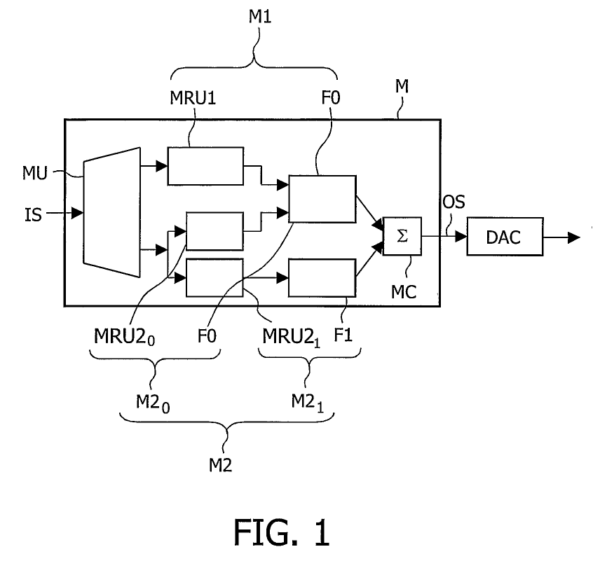

FIG. 1 schematically illustrates an example of joint 8PSK/GMSK I/Q modulator,

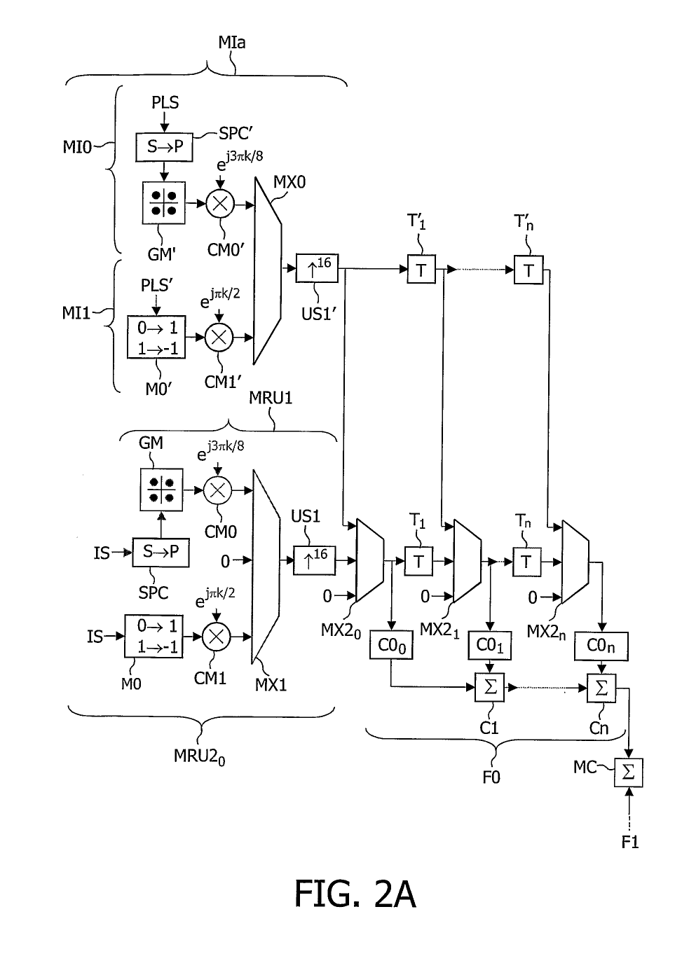

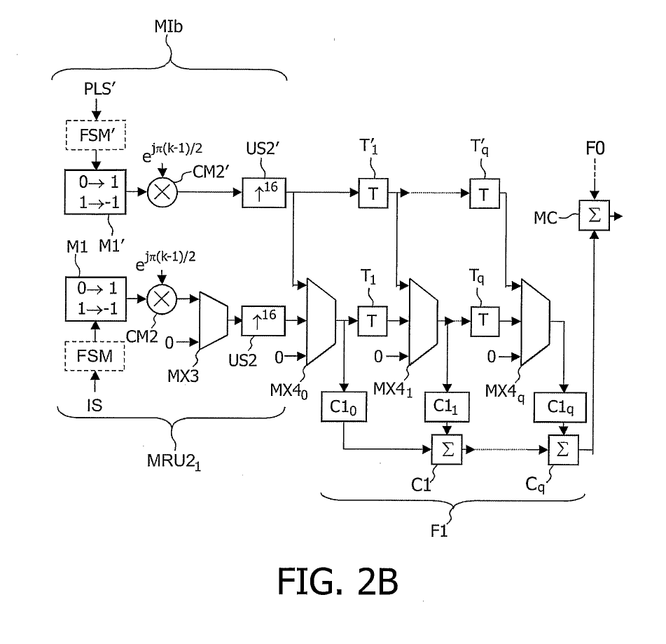

FIG. 2A schematically illustrates a simplified example of embodiment of the 8PSK I/Q modulator and the zero-th order path of the linearized GMSK I/Q modulator according to the invention,

FIG. 2B schematically illustrates a simplified example of embodiment of the first order (or quadratic) path of the linearized GMSK I/Q modulator according to the invention,

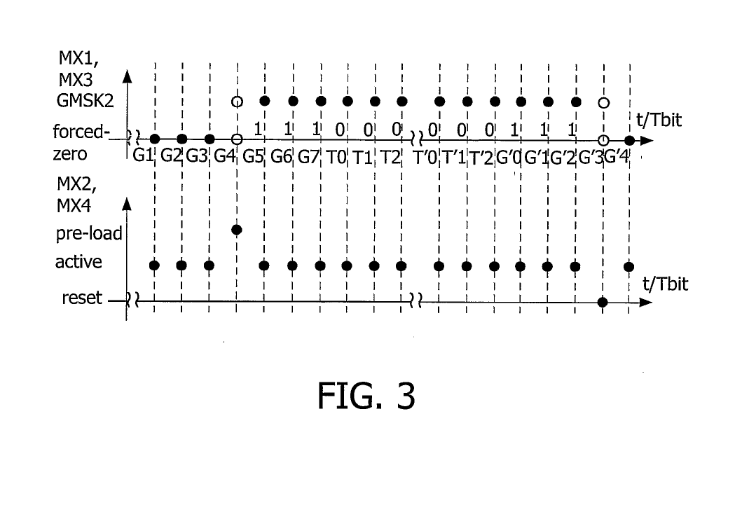

FIG. 3 schematically illustrates an example of timing diagrams for the linearized GMSK I/Q modulator of FIGS. 2A and 2B,

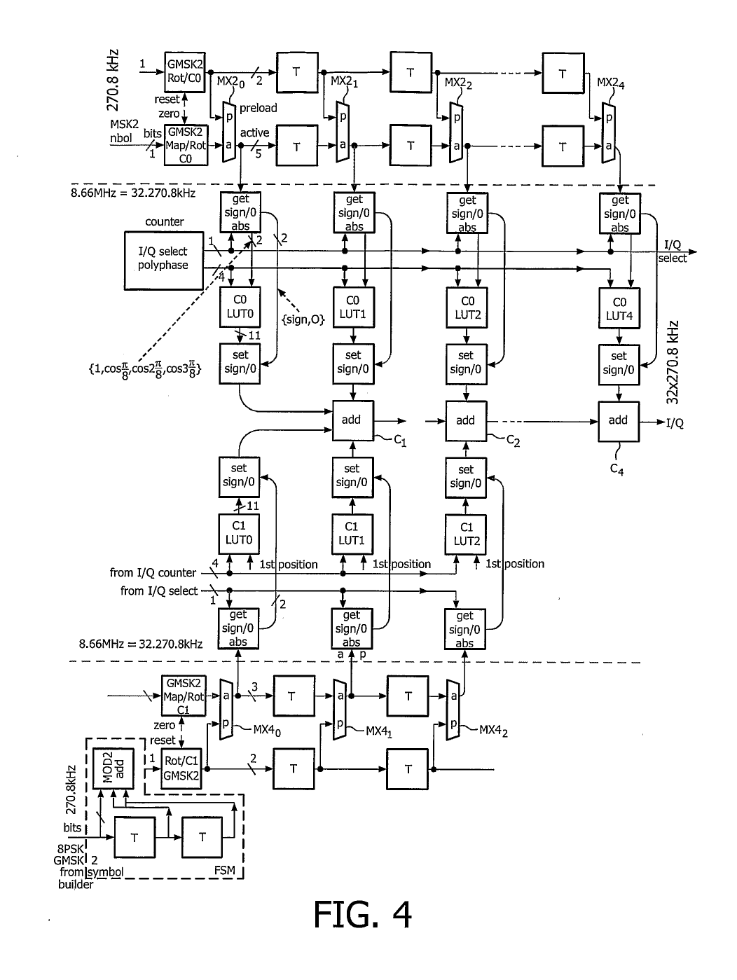

FIG. 4 schematically illustrates a detailed example of embodiment of the linearized GMSK I/Q modulator according to the invention, including pre-load and reset means, and

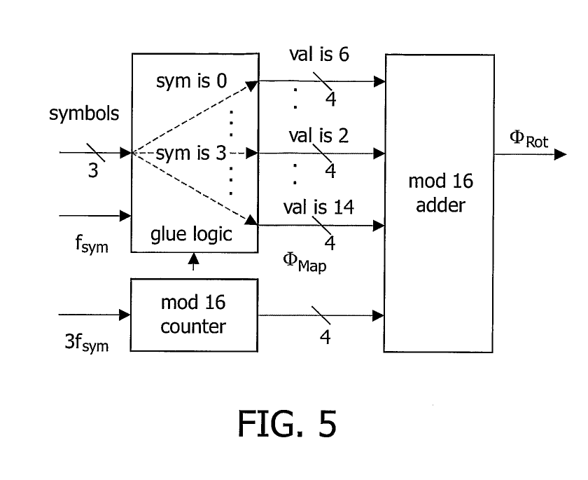

FIG. 5 schematically illustrates an example of modulo 16 counter and modulo 16 adder combination allowing the mapping of input symbols [0, 1, . . . , 7] to one out of 16 possible points on the unit circle where the angles of those points are multiples of 2π/16, taking additionally into account the angle correction of the k-th input sample by 2πk/16.

The appended drawings may not only serve to complete the invention, but also to contribute to its definition, if need be.

Reference is initially made to FIGS. 1 and 2 to describe an example of modulator M according to the invention, in a non limiting embodiment.

In the following description it will be considered that the illustrated modulator M is a joint 8PSK/GMSK I/Q modulator installed in a wireless communication equipment, such as a GSM mobile phone with enhanced data rate according to the EGPRS (or EDGE) standard. In other words the modulator M is adapted to switch in multimode operation from a GMSK modulation scheme to an 8PSK modulation scheme and vice versa in consecutive time slots of a GSM frame.

It is important to notice that the invention is not limited to this kind of switching which requires a switching between the linear and non-linear modes of a power amplifier. Indeed this invention generally applies to any switching schemes of modulators that are based on Laurent's construction of digitally phase modulated signals by superposition of amplitude modulation pulses. Some more details about this Laurent's construction may be found in the document of P.A. Laurent “Exact and approximate construction of digital phase modulations by superposition of amplitude modulated pulses (AMO)”, IEEE Transactions on communications, Vol. 42, No. 2/3/4, 1994.

Moreover, the invention is not limited to modulators installed in mobile phone. The modulator according to the invention may be installed in any wireless communication equipment, and notably in laptop or PDA (Personal Digital Assistant) comprising a communication device.

As it is known by one skilled in the art, a modulator M is part of the transmission section of a mobile phone (for instance). This transmission section schematically comprises a speech coder, a channel coder, an interleaver, a ciphering, a burst formatter, a joint 8PSK/GMSK I/Q modulator M, a digital to analog converter DAC for the baseband signal, a signal up-converter from baseband to radio frequency (RF), a RF power amplifier and a transmission antenna.

As it is schematically illustrated in FIG. 1 a joint 8PSK/GMSK modulator M generally comprises a multiplexer MU provided with digital input signals IS by the burst formatter and arranged to feed either an 8PSK I/Q modulator M1 or a linearized GMSK I/Q modulator M2 according to the type of the input signals IS to modulate.

The linearized GMSK I/Q modulator M2 preferably comprises a zero-th order modulation path M2₀, also named linear path, and at least a first order modulation path M2₁, also named quadratic path, fed with the same input signals IS. It is important to notice that the linearized GMSK I/Q modulator M2 is more generally a n-th order GMSK I/Q modulator which comprises n+1 modulation paths (n≧0) fed with the same input signals IS. Therefore the modulator according to the invention may comprise a GMSK I/Q modulator comprising more than two modulation paths.

The linear path comprises a mapping/rotation/up-sampling part MRU2₀ feeding a filter part F0, also named C0 filter. The quadratic path comprises a mapping/rotation/up-sampling part MRU2₁ feeding a filter part F1, also named C1 filter.

The 8PSK I/Q modulator M1 comprises a mapping/rotation/up-sampling part MRU1 feeding the C0 filter F0 that it shares with the linear path of the linearized GMSK I/Q modulator M2.

The respective outputs of the C0 filter F0 and C1 filter F1 are connected to the inputs of a main combiner MC to feed it with modulated I/Q signals. The output of the main combiner MC is connected to the digital to analog converter DAC to feed it with the modulated I/Q signals OS.

According to the invention the 8PSK I/Q modulator M1 and the linearized GMSK I/Q modulator M2 each comprise a modulation section for generating modulated digital I/Q signals associated to time slots of GSM frames and a filter section for applying a chosen pulse shape defined by filter values to the digital I/Q signals in order to output modulated digital I/Q signals OS.

The modulated digital I/Q signals may possibly have a dip in their envelope during the guard intervals inserted between consecutive time slots, as it is described in the above cited patent document WO 2004/021659 whose disclosure is fully incorporated by reference hereby. But this is not mandatory.

In WO 2004/021659 it is recalled that the dip is introduced in the signal envelope by taking advantage of the modulator's built-in C0/C1 filters and by feeding zeros to these filters during the guard period.

In the present invention a dip may be introduced by means of a digital signal processing (such as a multiplier) in the transmit section, for instance. This is for example proposed in the patent document EP 03104545.3 (filed on Dec. 4, 2003) where an additional multiplier is provided in the digital domain. The multiplier gains are chosen such that a smooth transition between consecutive bursts with different transmit powers is carried out during the guard interval. Alternatively, a dip may be introduced in the analog domain using an external power control loop (not illustrated) which can be controlled by the digital signal processor (DSP) being fed in turn with power amplifier measures.

With such an envelope dip, the unwanted abrupt switching transients in the transmission signals due to abrupt switching of the transmission section can be avoided. So, it is possible to minimize the interferences between adjacent transmission channels associated to consecutive time slots which previously occurred in case of a change of transmission power level between consecutive time slots. Moreover, the envelope dips allow to avoid unwanted discontinuities in the I/Q signals which appeared during switching between 8PSK and GMSK modulation schemes. So, it is possible to minimize the interferences between adjacent transmission channels associated to consecutive time slots which previously occurred in case of switching between 8PSK and GMSK modulation schemes.

It is important to notice that in WO 2004/021659 unwanted spoiling of the neighbouring spectrum has been taken care of by design because of the smooth signal step-on and step-off due to the zeros fed to the FIR filters. In the present invention one aims at decoupling the modulator step-on and step-off and the power control. Hence, the modulator M only makes sure that instantaneous reaction is possible whereas some additional processing has to ensure that proper power ramping occurs and that the spectral requirements are fulfilled. In other words the smooth step-on and step-off have to be done by other means.

Still according to the invention the modulator M comprises an initialization (or pre-load) means arranged, when it receives a burst of digital I/Q signals, to feed the filter means with chosen rotated valid symbols, time-aligned with consecutive guard bits and data bits filling a guard interval and the consecutive time slots that enclose it, before transmission of the last guard bits filling this guard interval to the filter section (“initialization mode”), and/or with digital I/Q signals set to zero, just after transmission of the last data of the transmit burst to the filter section (“reset mode”).

It will now be described a non limiting simplified example of embodiment of the modulator M according to the invention with reference to FIGS. 2A and 2B.

As it is schematically illustrated in FIG. 2A the mapping/rotation/up-sampling part MRU1 of the 8PSK PQ modulator M1 may comprise a serial to parallel converter SPC fed with serial data stream (or digital input signals) IS by the multiplexer MU of the modulator M. It is recalled that the speech signals (but it may be also pure data) may be quantized by the speech coder and then organized into data frames by the channel coder.

For instance the serial to parallel converter SPC is at least a three-bit serial to parallel converter that outputs three-bit parallel signals. Preferably it is a four-bit serial to parallel converter that outputs four-bit parallel signals where the LSB (Least Significant Bit) is used to distinguish between GMSK data and 8PSK data as well as between various active (or gain)/reset/pre-load modes.

The mapping/rotation/up-sampling part MRU1 of the 8PSK I/Q modulator M1 also comprises a Gray mapper GM fed with the three-bit parallel signals and arranged to map each bit triplet on one out of eight complex signals.

The mapping/rotation/up-sampling part MRU1 of the 8PSK I/Q modulator M1 also comprises a complex multiplier CM0 arranged to shape the I/Q signals output by the Gray mapper GM. More precisely, and as it will be described below in more details, the complex multiplier CM0 is responsible for the mapping of the k-th symbol it receives onto the unit circle. The complex multiplier CM0 multiplies each received signal by a rotation signal equal to exp(jk3π/8) to introduce a rotation of 3kπ/8 radians. So the multiplier CM0 outputs rotated symbols which allow to avoid zero crossings in the RF envelope.

The mapping/rotation/up-sampling part MRU1 of the 8PSK I/Q modulator M1 also comprises a “shared” 3×1 multiplexer MX1 comprising a first input fed by the output of the complex multiplier CM0, a second input for zero setting, a third input fed by a complex multiplier CM1 of the mapping/rotation/up-sampling part MRU2₀, and one output feeding with input samples an up-sampler US1 adapted to carry out an up-sampling aiming at inserting N−1 zeros after each input sample. For instance and as illustrated N=16.

The function of the multiplexer MX1 is to select between zeros during each guard period and the rotated 8PSK or GMSK symbols during the time slots (or active part of the bursts). Feeding the up-sampler US1 (and the following C0 filter F0) with zeros during the guard period enables a smooth step-on and step-off response of the C0 filter F0.

This up-sampler US1 feeds the shared filter part (or C0 filter) F0 with zeros or digital 8PSK or GMSK I/Q signals through a multiplexer MX2₀.

The serial to parallel converter SPC, the Gray mapper GM, the multiplier CM0, the shared multiplexer MX1 and the shared up-sampler US1 constitute the mapping/rotation/up-sampling part MRU1 of the 8PSK I/Q modulator M1.

The C0 filter F0 is a pulse-shaping filter which has for instance 80 taps C0ᵢ (i=0 to n, where n=79) and may be split into m sections F0ₛ (s=1 to m), where m=1 to 80, each having 80/m filter coefficients C0ᵢ (for instance when m=5 there are 5 sections each having 16 taps). This C0 filter F0 is used for 8PSK and shared with the zero-th order part of the GMSK modulator. It is recalled that in GSM, the time-bandwidth product is BTbit=0.3 and the Gaussian pulse is treated as limited to −2Tbit . . . 2Tbit (where Tbit designates the GMSK data bit symbol period).

The C0 pulse-shaping filter F0 is preferably a low pass filter defining a finite impulse response (FIR) filter. Such a low pass filter is described in the document of P. Jung, “Laurent's representation of binary digital continuous phase modulated signals with modulation index ½ revisited,” IEEE Trans. Comm., vol. 42, pp 221-224, 1994.

Each part F0, of the C0 pulse-shaping filter F0 applies a chosen pulse shape defined by filter values (or coefficients) C0ₛ to the digital I/Q signals it receives in order to output modulated digital I/Q signals OS. The signal serially travels through all F0ₛ.

Each filter coefficient C0ᵢ of the C0 pulse-shaping filter F0 is fed with the same signal stream (possibly time delayed) through a multiplexer MX2ᵢ. More precisely, the filter coefficient C0₀ is fed by the output of the multiplexer MX2₀, which also feeds one of the three inputs of the following multiplexer MX2₁ through a module T₁. The filter coefficient C0₁ is fed by the output of the multiplexer MX2₁, which also feeds one of the three inputs of the following multiplexer MX2₂ through a module T₂, and so on. And finally, the filter coefficient C0ₙ is fed by the output of the multiplexer MX2ₙ through a module Tₙ. Each module T₁ (i=1 to n) is arranged to introduce a chosen delay in time domain. This delay corresponds to Tbit/N.

In the illustrated example, the C0 filter F0 also comprises n combiners (or adders) C1 to Cn for combining together the signals respectively output by each of its n+1 filter coefficients C0ᵢ. So the output of the last combiner (or adder) Cn of the C0 filter F0 is connected to one of the two inputs of the main combiner MC, whose output is connected to the digital to analog converter DAC.

The zero-th order modulation path (MRU2₀ and F0) of the linearized GMSK I/Q modulator M2 comprises a mapper M0 arranged to map each received signals on one out of two complex signals.

The zero-th order modulation path also comprises a complex multiplier CM1 arranged to rotate the I/Q signals output by the mapper M0. The complex multiplier CM1 is responsible for rotating the symbols it receives on the unit circle (the mapper M0 outputs the possible symbols −1, 1 and the complex multiplier CM1 rotates these values on the unit circle choosing one out of four possible positions). The complex multiplier CM1 multiplies each received signal by a rotation signal equal to exp(jkπ/2) to introduce a rotation of kπ/2 radians.

The multiplier CM1 is connected to the third input of the above mentioned shared 3×1 multiplexer MX1.

The mapper M0, the multiplier CM1, the shared multiplexer MX1 and the shared up-sampler US1 constitute the mapping/rotation/up-sampling part MRU2₀ of the GMSK I/Q modulator M2.

The mapping/rotation/up-sampling part MRU1 and the mapping/rotation/up-sampling part MRU2₀ constitute all together a module named Map/Rot C0 (in FIG. 4 this module is named GMSK2 Map/Rot C0).

The first order (or quadratic) modulation path (MRU2₁ and F1) of the linearized GMSK I/Q modulator M2 comprises a Finite State Machine FSM fed with the same digital GMSK signals like the mapper M0 of the zero-th order modulation path (MRU2₀ and F0). For instance the Finite State Machine FSM comprises first and second registers and first and second modulo 2 adders. The input of the Finite State Machine FSM feeds the first register and the first modulo 2 adder, while the output of the first register feeds the second register and the first modulo 2 adder. Finally the outputs of the second register and first modulo 2 adder fed the second modulo 2 adder whose output is the output of the Finite State Machine FSM.

The first order modulation path also comprises a mapper M1 arranged to map each signal coming from the Finite State Machine FSM on one out of the two possible signal values −1 and 1.

The first order modulation path also comprises a complex multiplier CM2 arranged to shape the I/Q signals output by the mapper M1. The complex multiplier CM2 multiplies each received signal by a rotation signal equal to exp(j(k−1)π/2) to introduce a rotation of (k−1)π/2 radians.

The first order modulation path also comprises a 2×1 multiplexer MX3 comprising one input fed by the output of the complex multiplier CM2, one input for zero setting and one output feeding with input samples an up-sampler US2 adapted to carry out an up-sampling aiming at inserting N−1 zeros after each input sample. For instance and as illustrated N=16.

The function of the multiplexer MX3 is to select between zeros during each guard period and the mapped and rotated GMSK symbols during the time slots (or active part of the bursts).

The Finite State Machine FSM, the mapper M1, the complex multiplier CM, the multiplexer MX3, and the up-sampler US2 define together the mapping/rotation/up-sampling part MRU2₁ of the first order modulation path of the linearized GMSK I/Q modulator M2. This mapping/rotation/up-sampling part MRU2₁ is also referenced as GMSK2 Map/Rot C1 in FIG. 4.

The up-sampler US2 feeds the filter part (or C1 filter) F1 with zeros or digital GMSK I/Q signals through a multiplexer MX4₀.

The C1 filter F1 is a pulse-shaping filter which has for instance 48 taps C1ⱼ (j=0 to q, where q=47) and is split into p sections (F1ₚ, where p=1 to 3 in this example), each having 16 filter coefficients C1ⱼ. The filter lengths of both filters F0 and F1 have to be the same, namely 80 taps (so, q=n). However, the upper 32 taps of the C1 filter F1 are 0, so they do not have to be realized. It is important to notice that in order to insure a proper time alignment, the summation between the output of the C0 filter F0 and C1 filter F1 has to be done properly.

The C1 pulse-shaping filter F1 is preferably a low pass filter defining a finite impulse response (FIR) filter. Such a low pass filter is also described in the above mentioned document of P. Jung.

Each part F1ⱼ of the C1 pulse-shaping filter F1 applies a chosen pulse shape defined by filter values (or coefficients) C1ⱼ(t) to the digital I/Q signals it receives in order to output modulated digital I/Q signals.

Each filter coefficient C1ⱼ of the C1 pulse-shaping filter F1 is fed with the same signal stream (or a delayed version of it) through a multiplexer MX4ⱼ. More precisely, the filter coefficient C1₀ is fed by the output of the multiplexer MX4₀, which also feeds one of the three inputs of the following multiplexer MX4₁ through a module T₁. The filter coefficient C1₁ is fed by the output of the multiplexer MX4₁, which also feeds one of the three inputs of the following multiplexer MX4₂ through a module T₂, and so on. And finally, the filter coefficient C1_{q} is fed by the output of the multiplexer MX4_{q} through a module T_{q}.

In the illustrated example, the C1 filter F1 also comprises q combiners (or adders) C1 to Cq for combining together the signals respectively output by each of its q+1 filter coefficients C1ⱼ. So the output of the last combiner (or adder) Cq of the C1 filter F1 is connected to one of the two inputs of the main combiner MC, whose output is connected to the digital to analog converter DAC.

According to the invention and as illustrated in FIGS. 2A and 2B, the joint modulator M comprises initialization means for loading the FIR filter states with a “dummy” sequence of valid symbols during the guard period between two time slots, i.e. before the transmission of the active part of the transmit burst (pre-load mode), and/or with digital I/Q signals set to zero just after the active part of a transmit burst (reset mode).

More precisely, the pre-load part of the initialization operation aims at loading all the flip-flops in the C0 FIR filter F0 and C1 FIR filter F1 (modules T (for delay in time domain)) with valid symbols. A valid symbol is any possible bit combination out of the GMSK (or 8PSK) alphabet and properly rotated.

The rotation part is very important because it avoids the delay associated with the FIR filter when all zero is the initial state. Moreover, the rotation of the dummy sequence allows to switch between a dummy sequence and data bits without phase jumps. Effectively, an input signal will have to travel first through the filter before being fully visible at the output. This can be avoided when a valid dummy sequence of rotated valid symbols is loaded into the FIR filters during the guard period. In this way, it is possible to generate a specific signal which is compliant with the power-time template.

With this kind of initialization one can obtain a sharp transition from a very small amplitude (due to the absence of transmission during the guard period) to the required amplitude level.

The initialization (or pre-load) means may be divided in two parts: a first one MIa dedicated at least to the zero-th order path (MRU2₀ and F0) of the linearized GMSK I/Q modulator M2, and also possibly to the 8PSK I/Q modulator M1 (as illustrated in FIG. 2A), and a second one MIb dedicated to the first order path (MRU2₁ and F1) of the linearized GMSK I/Q modulator M2 (as illustrated in FIG. 2B).

In the example illustrated in FIG. 2A, the first part MIa of the initialization (or pre-load) means comprises a sub part MI0 dedicated to the 8PSK I/Q modulator M1 (and which is not mandatory when GMSK switching is only used) and a second part MI1 dedicated to the zero-th order path (MRU2₀ and F0) of the linearized GMSK I/Q modulator M2.

The first sub part MI0 comprises a serial to parallel converter SPC′ fed with a chosen sequence of initialization (or pre-load) bits PLS. As the serial to parallel converter SPC, this serial to parallel converter SPC′ is for instance a three-bit serial to parallel converter that outputs three-bit parallel signals PLS.

The first sub part MI0 also comprises a Gray mapper GM′ fed with the three-bit parallel signals and arranged to map each bit triplet on one out of eight complex signals.

The first sub part MI0 also comprises a complex multiplier CM0′ arranged to rotate the signals output by the Gray mapper GM′. The complex multiplier CM0′ multiplies each received signal by a rotation signal equal to exp(jk3π/8) to introduce a rotation of 3kπ/8 radians. So the multiplier CM0′ outputs rotated symbols which allow to properly phase-align them with the input data when switching between pre-load, reset and active modes.

In an alternative it is possible to generate input sequences in which all the bits are equal to zero (0) or one (1). For this purpose it is possible to hardwire the complex multiplier CM0′ input to minus one (−1) or one (1), thus omitting the serial to parallel converter SPC′ and also the Gray mapper (or even the whole branch if the 8PSK initialization switching is not foreseen).

The second sub part MI1 comprises a mapper M0′ fed with a chosen sequence of initialization (or pre-load) bits PLS′, and arranged to map each bit on one out of two complex signals as the mapper M0.

The second sub part MI1 also comprises a complex multiplier CM1′ arranged to rotate the signals output by the mapper M0′. The complex multiplier CM1′ multiplies each received signal by a rotation signal equal to exp(jkπ/2) to introduce a rotation of kπ/2 radians. So the multiplier CM1′ outputs rotated symbols which allow to properly phase-align them with the input data when switching between pre-load, reset and active modes.

In an alternative it is possible to generate input sequences in which all the bits are equal to zero (0) or one (1). For this purpose it is possible to hardwire the complex multiplier CM1′ input to minus one (−1) or one (1), thus omitting the mapper M0′.

The first part Mia of the initialization means also comprises a shared 2×1 multiplexer MX0 comprising a first input fed by the output of the complex multiplier CM0′, a second input fed by the complex multiplier CM1′, and one output feeding with input samples an up-sampler US1′ adapted to carry out an up-sampling aiming at inserting N−1 zeros after each input sample in order to output the chosen valid rotated bits for the initialization (or pre-load) mode. In the illustrated example N is equal to 16.

The function of the multiplexer MX0 is to select between the rotated 8PSK and GMSK symbols during the pre-load mode (when it is implemented, i.e. when the initialization of the 8PSK path is foreseen).

The output of the up-sampler US1′ is connected to the first input of the multiplexer MX2₀ and to each first input of each other multiplexer MX2₁ to MX2_{q} respectively through modules T′₁ to T′_{q} (delay in time domain modules).

So the first input of each multiplexer MX2ᵢ is fed with rotated signals for initialization (or pre-load) mode purpose, the second input of each multiplexer MX2ᵢ is fed with rotated signals for active mode purpose, and the third input of each multiplexer MX2ᵢ is fed with zeros for a reset mode purpose.

The first part MIa is also named Rot/C0 module (in FIG. 4 this module is named GMSK2 Rot/C0 (only the GMSK initialisation is shown)).

The second part MIb of the initialization (or pre-load) means comprises a Finite State Machine FSM preferably fed with the same chosen sequence of initialization (or pre-load) bits PLS′ than the mapper M0′.

The second part MIb also comprises a mapper M1′ arranged to map each signal coming from the Finite State Machine FSM′ on one out of two complex signals.

The second part MIb also comprises a complex multiplier CM2′ arranged to shape the signals output by the mapper M1′. The complex multiplier CM2′ multiplies each received signal by a rotation signal equal to exp(j(k−1)π/2) to introduce a rotation of (k−1)π/2 radians. So the multiplier CM2′ outputs rotated symbols which allow to properly phase align them when switching between active, pre-load and reset modes.

The second part MIb also comprises an up-sampler US2′ fed by the output of the multiplier CM2′ with the rotated symbol samples and adapted to carry out an up-sampling aiming at inserting N−1 zeros after each sample in order to output the chosen valid rotated bits for the initialization (or pre-load) mode. In the illustrated example N=16.

The output of the up-sampler US2′ is connected to the first input of the multiplexer MX4₀ and to each first input of each other multiplexer MX4₁ to MX4_{q} respectively through modules T′₁ to T′_{q} (delay in time domain modules).

So the first input of each multiplexer MX4ⱼ is fed with rotated signals for initialization (or pre-load) mode purpose, the second input of each multiplexer MX4ⱼ is fed with rotated signals for active mode purpose, and the third input of each multiplexer MX4ⱼ is fed with zeros for a reset mode purpose.

The second part MIb is also named Rot/C1 module (in FIG. 4 this module is referenced GMSK2 Rot/C1).

In an alternative it is possible to generate input sequences in which all the bits are equal to zero (0) or one (1). For this purpose it is possible to hardwire the complex multiplier CM2′ input to minus one (−1) or one (1), thus omitting the mapper M2′ and the Finite State Machine FSM′.

One can notice that for the pre-load mode the complex multipliers CM1 and CM2 may comprise an additional input fed with a chosen constant value and respectively with the exp(jkπ/2) and exp(j(k−1)π/2) terms, which results in the omission of the mappers M0 and M1. This is possible because the initialization (or pre-load) needs to be done only with valid and properly rotated symbols (or bits). For this purpose it is possible to hardwire the additional input to 1 (or −1) and still rotating by the CMi's results in a properly rotated dummy sequence which can be phase aligned with the active mode, i.e. switched without introducing phase jumps. In this case, it is also possible to omit the Finite State Machine FSM (which acts as a modulo 2 adder in this special case) because it calculates the same output for every constant input.

According to the invention and as illustrated in FIGS. 2A and 2B, the initialization means of the joint modulator M may also comprise reset means for loading the FIR filter states with a chosen “dummy” sequence (which does not comprise necessary valid symbols) just after the transmission of the active part of the burst. This chosen “dummy” sequence is provided to obtain a fast transition of the FIR filter states from the last valid symbol (with the transmitted amplitude) to the all zero state of the guard period which corresponds to a very small amplitude.

The chosen dummy sequence is a sequence of digital I/Q signals set to zero.

It is important to notice that in the reset mode digital I/Q signals set to zero are fed into the FIR filters, while in the pre-load mode the initialization means is fed with GMSK or 8PSK zero (0) or one (1) which are then mapped onto digital I/Q signals respectively equal to minus one (−1) or one (1), and then a chosen rotation is applied to the resulting digital I/Q signals, which lie on the unit circle, before they are fed into the FIR filters.

The reset dummy sequence may be introduced through the third input of each multiplexer MX2ᵢ or MX4ⱼ, or else through the first input of each multiplexer MX2ᵢ or MX4ⱼ (dedicated to the pre-load (or initialization) signals) when it is generated by the initialization (or pre-load) means (in this case the initialization means also acts as a reset means).

FIG. 3 illustrates a possible timing diagram for the linearized GMSK I/Q modulator M2 and more precisely for its multiplexers MX1 or MX3 (in the upper part) and for its multiplexers MX2 and MX4 (in the lower part).

Here the pre-loading (or initialization) takes place after the four leading guard bits referenced G1 to G4 which are followed by some specially defined other guard bits G5 to G7.

These guard bits filled the guard interval which is inserted between two consecutive time slots filled with data bits.

More precisely, in this example, the guard period takes G1, . . . , G7 (guard bits) but the modulator M2 is switched on only after G4. So, during G1, G2 and G3 the multiplexers MX1 and MX3 are set to forced zero (second input on) while the multiplexers MX2 and MX4 are set to active (second input on). So, a smooth step-down from the previous GMSK burst is obtained. At G4, the multiplexers MX1 and MX3 are switched to GMSK2 (first input on) while the multiplexers MX2 and MX4 are set to pre-load (first input on) to enables the dummy sequence to be pre-loaded into the C0 and C1 filters. Thus, a fast amplitude transition occurs at the output and new data bits follow the dummy sequence and “real data” reach the output after 2.5 symbol periods (i.e. after 2.5 Tbit).

In FIG. 3 tail bits T0 to T2 are followed by data bits (not shown and corresponding to a “normal” transmission), which are followed by other tail bits T′0 to T′2, and t/Tbit designates “normalized time scale”.

In this example, the resetting part (forced zero) follows after the third trailing guard bit G′3, i.e. after the active part of the burst and after an additional transmission of three more specially defined guard bits (G′0 to G′2). The reset mode could be activated already during G′0 but in practice it is preferable to introduce some time for the switch-off process.

One now refers to FIG. 4 to describe a more detailed example of embodiment of the linearized GMSK I/Q modulator M2 according to the invention.

In this example one considers that the modulator M time interleaves the in-phase signal I and the quadrature signal Q and therefore runs 2 times faster than a modulator in which the in-phase signal I and the quadrature signal Q are processed in parallel. But this is not mandatory.

Moreover, this example only describes the zero-th order path (MRU2₀ and F0) and the first order path (MRU2₁ and F1) of the linearized GMSK I/Q modulator M2, but not the 8PSK I/Q modulator M1. But, regarding that the GMSK modulator's zero-th order path (MRU2₀ and F0) and the 8PSK I/Q modulator M1 share the C0 filter F0, addition of the latter in FIG. 4 only requires to consider that the GMSK2 Map/Rot C0 module comprises an additional 8PSK Mapping/Rotation module (Mapping/Rotation for 8PSK is different from Mapping/Rotation for GMSK) for 8PSK and that the GMSK2 Rot/C0 module comprises an additional input for 8PSK pre-load signals (as in FIG. 2A), and to proceed as described below.

More, in this example the multiplexers MX2ᵢ and MX4ⱼ each only comprise a first input (p) for initialization (or pre-load) signals and a second input (a) for the active I/Q signals, but they may also comprise a third input for reset signals as in FIGS. 2A and 2B. One can also consider that the first input (p) is used both for pre-load signals and reset signals.

For the 8PSK signals, the 8PSK Map/Rot C0 module encodes the 16 possible states of the rotated PSK symbols into 4 bits. In addition one may provide a forced-zero flag to indicate whether the C0 filter F0 must be fed with rotated 8PSK symbols or with zeros.

The symbol mapping combines the signals output by the Gray mapper GM as well as the additional rotation symbol of the exp(j3πk/8) term. The Gray mapper GM can be seen as a group of gates which translates the 3-bit symbols into the corresponding position on a unit circle according to the following rule (in this example the unit circle comprises 2π/16 parts) symbol [0, 1, 2, 3, 4, 5, 6, 7]→[6, 8, 4, 2, 12, 10, 14, 0]

A modulo 16 counter running at triple speed and a modulo 16 adder combination is taking care of the angle correction when it is implemented according to the following rule Φ_{Rot}(k)=mod₁₆(Φ_{Map}(k)+mod₁₆(3k))=mod₁₆((DM₈p(k)+3k) where k starts from zero (0) and Φ_{Map} and Φ_{Rot} are introduced in the block diagram illustrated in FIG. 5.

For the GMSK signals, the GMSK2 Map/Rot C0 or C1 module takes care of the correct bit to symbol mapping and rotates with an exp(jπ(k−M)/2) term, where M=0 for C0 and M=1 for C1.

As in the case of 8PSK signals, the mapper M0 or M0′ translates the incoming symbols into the corresponding position on a unit circle according to the following rule (presupposing in this example that the angles of those positions are integer multiples of 2π/16):symbol [0, 1]→[0, 8].

A modulo 16 counter running at four times the speed and a modulo 16 adder combination is taking care of the angle correction when it is implemented according to the following rules:

for C0, M=0, Φ_{Rot}(k)=mod₁₆(Φ_{Map}(k)+mod₁₆(4k))=mod₁₆(Φ_{Map}(k)+4k)
for C1, M=1, Φ_{Rot}(k)=mod₁₆(Φ_{Map}(k)+mod₁₆(4(k−1)))=mod₁₆(Φ_{Map}(k)+4(k−1)).

The implementation of these rules requires a simple adaptation of the block diagram illustrated in FIG. 5.

Contrary to FIGS. 2A and 2B, in the illustrated example of FIG. 4 the C0 filter F0 and the C1 filter F1 share the same combiner (or adder). Therefore the main combiner MC is not required. More, only m−1 combiners C1 . . . C4 are provided for the m=5 C0 filter parts.

Moreover each of the m=5 parts of the C0 filter F0 and each of the p=3 parts of the C1 filter F1 comprises a look up table respectively named C0 LUTr (here r=0 to m−1) and C1 LUTv (here v=0 to p−1) coupled to a first module named get sign/0 abs and to a second module named set sign/0.

Each module get sign/0 abs is arranged to determine the sign and the absolute value of Re{e^{jΦRot(k)}} or Im{e^{jΦRot(k)}} depending on the I/Q select bit provided by an I/Q select polyphase counter (also connected to each C0 LUTr and C1 LUTv).

The I/Q select polyphase counter comprises a counter part adapted to process binary weights up to 16 and a I/Q select part to select between I and Q digital signals.

The size of the look up table is kept small in order to address the C0 LUTr or C1 LUTv with all possible absolute values |Re{e^{jΦRot(k)}}| or |Im{e^{jΦRot(k)}}| which are {1, cos(π/8), cos(2π/8), cos(3π/8), 0}. The four non-zero values are coded in 2 bits. The 0 value and the sign are coded in two other bits. The former 2 bits coded absolute values and the 4 bit of the polyphase counter form the 6 bit address of the C0 LUTr or C1 LUTv.

Each set sign/0 module sets the sign of the C0 LUTr or C1 LUTv output or sets it to zero.

Preferably, the data word lengths of the C0 LUTr and C1 LUTv are slightly larger than the preferred DAC resolution of about 10 bits to avoid rounding errors.

The get-sign operation needs inputs from the I/Q select part of the I/Q select polyphase counter as well as from one symbol delay line T.

The sign bit for the Q-signal (imaginary part) can be mapped according to the following rules (thereby we use the following definitions I_{ΦRot}=Re{e^{jΦRot(k)}} and Q_{Φrot}=Im{e^{jΦRot(k)}}):

sign(Q_{ΦRot}): positions [1, 2, 3, 4, 5, 6, 7]→decimal value +1
sign(Q_{ΦRot}): positions [9, 10, 11, 12, 13, 14, 15]→decimal value −1
sign(Q_{ΦRot}): positions [0, 8]→decimal value 0

The sign bit for the I-signal (real part) can be mapped according to the following rules:

sign(I_{ΦRot}): positions [13, 14, 1, 0, 1, 2, 3]→decimal value +1
sign(I_{ΦRot}): positions [5, 6, 7, 8, 9, 10, 11]→decimal value −1
sign(I_{ΦRot}) positions [4, 12]→decimal value 0

With such rules the decimal values +/−1 can be coded into one bit and the decimal value 0 can be combined with the forced-zero signal. The sign bit as well as the forced-zero bit are then fed to the appropriate set sign/0 modules. One can notice that the forced-zeros bit can be used to set I/Q signals to a zero value but also to set only one of the two to zero. This is necessary since the look up tables do not have a zero-entry position for I/Q signals.

Moreover, the 4-bit inputs of the C0 LUTr and C0 LUTv modules containing the position (angle) of the signal on the unit circle are mapped onto the first quadrant, i.e. to {1, cos(π/8), cos(2π/8), cos(3π/8)}. So, no information is lost during this operation since I and Q signals are processed separately and since the signs of the respective signals are known.

The mapping for 1 and Q signals can be done according to the following rules:

posLUT(Q_{ΦRot}): positions [(0*, 4, 8, 12*), (1, 7, 9, 15), (2, 6, 10, 14), (3, 5, 11, 13)]→[1, cos(π/8), cos(2π/8), cos(3π/8)]
posLUT(I_{ΦRot}): positions [(0, 4*, 8*, 12), (3, 5, 11, 13), (2, 6, 10, 14), (1, 7, 9, 15)]→[1, cos(π/8), cos(2π/8), cos(3π/8)]

For instance, the position values (1, 7, 9, 15) of the Q-signal are mapped to cos(π/8) which is the second entry of the look up table. All the position values having an asterix will be pointing to wrong table entries, i.e. position “0” of the Q-signal will be mapped to the first entry of the table (because the imaginary part of this position must be zero). However the sign bit of this position values takes care of this situation and flushes the set sign/0 module with forced-zero entry.

One can notice that the sizes of the C0 LUTr and C1 LUTv modules can be reduced if necessary. Effectively, C0 LUT0 is a mirrored version of C0 LUT4, C0 LUT 1 is a mirrored version of C0 LUT3, and C0 LUT2 can be mirrored around its own symmetry axis. So, one can use the symmetry of the C0/C1 coefficients to optimize the sizes of the C0 LUTr and C1 LUTv modules.

Moreover, simple changes in the I/Q select polyphase counter can allow to save half of the look up tables at the expense of a faster read-out time. No change is necessary for the counters of C0 LUT0 and C0 LUT1. The counters of C0 LUT3 and C0 LUT4 simply run in reverse order and the counter for C0 LUT2 runs from 0 . . . 7 and back from 7 . . . 0. In doing so, C0 LUT3 and C0 LUT4 and half of C0 LUT2 can be dropped. A similar solution can be established for the C1 coefficients.

The invention is not limited to the embodiments of modulator described above, only as examples, but it encompasses all alternative embodiments which may be considered by one skilled in the art within the scope of the claims hereafter.

1. Modulator for a wireless communication equipment, comprising i) a modulation means
for generating digital I/Q signals associated to time slots of a group of time slots, filled with data bits of a burst and separated one from the others by a guard interval filled with guard bits, and ii) a filter means for applying a chosen pulse shape defined by filter values to said digital I/Q signals to output modulated digital I/Q signals, characterized in that it comprises initialization means
arranged, upon reception of a transmit burst of digital I/Q signals, to feed said filter means with chosen rotated valid symbols, time-aligned with consecutive guard bits and data bits respectively filling guard interval and the consecutive time slots that enclose it, before transmission to said filter means of the last guard bits filling said guard interval, and/or with digital I/Q signals set to zero just after transmission to said filter means of the last data of said transmit burst.

2. Modulator according to claim 1, characterized in that said initialization means is arranged to feed a processing means input of said modulation means with a chosen constant value in association with the feeding of the filter means with said chosen rotated valid symbols.

3. Modulator according to claim 2, characterized in that said constant value is equal to “1”.

4. Modulator according to claim 2, characterized in that said constant value is equal to “0”.

5. Modulator according to claim 1, characterized in that it comprises reset means arranged to feed said filter means just after transmission to said filter means of the last data of said received burst, with a reset sequence of signals forced to zero in order said filter means outputs modulated digital I/Q signals forced to zero.

6. Modulator according to claim 1, characterized in that said modulation means comprises at least first second and third modulation means, said initialization means comprises at least first and second initialization means, and said filter means comprises at least a first filter means coupled to said first and third modulation means through a first multiplexing means and a second filter means coupled to said second modulation means through a second multiplexing means

7. Modulator according to claim 6, characterized in that said first and second filter means are finite impulse response filters each divided into stages and outputting respectively first and second modulated digital I/Q signals, and that it comprises combination means arranged to combine said first and second modulated digital I/Q signals to constitute said modulated digital I/Q signals.

8. Modulator according to claim 6, characterized in that said initialization means comprises a third initialization means.

9. Modulator according to claim 5, characterized in that said first second and third initialization means each comprise at least a mapper respectively fed with a chosen bit sequence and a multiplier comprising a first input coupled to said mapper and a second input fed with chosen rotation signals and adapted to deliver said rotated valid symbols as a function of said rotation signals and said chosen bit sequence.

10. Modulator according to claim 9, characterized in that said second initialization means also comprises a finite state machine fed with said chosen bit sequence and feeding said mapper

11. Modulator according to claim 9, characterized in that said third initialization means also comprises a serial to parallel converter fed with said chosen bit sequence and feeding said mapper

12. Modulator according to claim 6, characterized in that said first and third initialization means share a multiplexer comprising at least first and second inputs respectively connected to said multipliers and one output feeding a shared up-sampler connected to the first filter means

13. Modulator according to claim 4, characterized in that said shared multiplexer comprises a third input for introducing said reset sequence of signals forced to zero.

14. Modulator according to claim 6, characterized in that said first and second initialization means are fed with a same chosen bit sequence.

15. Modulator according to claim 6, characterized in that said first modulation means and said first filter means (F0) define a zero-th order of a linearized GMSK I/Q modulator, said second modulation means and said second filter means define a first order of said linearized GMSK I/Q modulator, said zero-th order and said first order of said linearized GMSK I/Q modulator being fed with common digital GMSK I/Q signals, and said third modulation means and said first filter means define and 8PSK I/Q modulator fed with digital GMSK I/Q signals.

16. Wireless communication equipment, characterized in that it comprises a modulator according to claim 1.
